(19) United States
(12) Patent Application Publication
(10) Pub. No.: US 2019/0276174 A1
(43) Pub. Date: Sep. 12, 2019

(54) DEVICE FOR FILLING A BAG, BAG CONTOUR SEALING TOOL, SEALING TOOL, METHOD FOR FILLING A BAG, METHOD FOR PRODUCING A BAG, SYSTEM AND BAG

(71) Applicant: KIEFEL GmbH, Freilassing (DE)

(72) Inventors: Rupert Gschwendtner, Bad Reichenhall (DE); Martin Klein, Hallein (AT); Johann Haas, Köstendorf (AT)

(21) Appl. No.: 16/304,736

(22) PCT Filed: Jul. 21, 2017
(86) PCT No.: PCT/DE2017/000217

§ 371 Date: Nov. 27, 2018

(30) Foreign Application Priority Data
Aug. 26, 2016 (DE) 10 2016 010 247.0
Apr. 20, 2017 (DE) 10 2017 003 802.3
Jul. 20, 2017 (DE) 10 2017 006 886.0

(51) Int. Cl. B65B 39/08; B65B 3/00; B65D 75/58; B65B 51/22; A61J 1/10; A61J 1/14; B65B 43/02; B29C 65/02; B29C 65/00

(52) U.S. Cl. CPC B65B 39/08; B65B 3/003; B65D 75/5883; B65B 51/227; A61J 1/10; B29L 2031/7148; B65B 43/02; B29C 65/02; B29C 66/53262; B29C 66/849; B29C 66/814; A61J 1/1475

(57) ABSTRACT

The invention relates to a device for filling a bag, a bag contour welding tool for manufacturing a bag, a welding tool for welding a bag, a method of filling a bag, a method of manufacturing a bag, a plant for manufacturing and filling a bag and to a bag which has been manufactured and filled with such a plant or which has been manufactured with a bag contour welding tool.

The invention allows a filling of a bag, in particular a bag for medical purposes, without the necessity of providing a filling port on the bag.

In this way, resources and costs can be saved, preventing damage to the environment.

The invention refers to a method of filling a bag, a bag contour welding tool, a welding tool, a method of filling a bag, a method of manufacturing a bag, a plant and a bag.

Ever more increasing attention is directed at the manufacturing of bags which will finally be used as medical products.

In the state of the art, various manufacturing methods for such bags are known.

One very common example is disclosed in WO2007/140760A2, where bags are produced which have a connecting part for filling and/or emptying of the bag and which are finally used in particular as medical products. For manufacturing the necessary discharge component of the bag, a tubular connecting part is welded between two foils. For this purpose, the tubular connecting part is arranged at a mandrene also called central electrode. The foils are arranged in a planar position above and below the connecting part. A tool then approaches the foils, and while the upper and the lower tool are moved closer to each other arranges them in a planar position around the connecting part in a connecting area, until the foils are in contact with each other next to the connecting area. Then a welding connection is produced on the one hand between the connecting part and the foils and, on the other hand, outside the connecting area directly between the foils.

WO2010/025699A1 discloses a device for welding a connecting area of a foil to a connecting part, in particular of two foils to a tubular connecting part, where in a first step, the foil is elongated outside the connecting area in a controlled manner so that the foil has a spare area in the longitudinal direction, which spare area contravenes in the second step, during welding, an uncontrolled weakening of the foil in the area of the connecting part.

The object of the invention is to provide the state of the art with an improvement or an alternative.

In a first aspect of the invention, the object is achieved by a device for filling a bag, the device having a clamp with two clamping jaws and a filling needle, the clamp being adapted to clamp the bag between the filling needle and the clamping jaws.

Some terminology will be explained in the following:

First, it is explicitly pointed out that within the framework of the present patent application, indefinite articles and numerals such as “one”, “two” etc. are to be normally understood as indicating a minimum, i. e. “at least one . . . ”, “at least two . . . ” etc., unless it is explicitly clear from the context, obvious to the person skilled in the art or technically inevitable that only “precisely one . . . ”, “precisely two . . . ” etc. can be intended.

A “bag” is a hollow, thin-walled, easily deformable object suitable for receiving other objects, in particular liquids. A bag may be an open or closed bag.

A “clamp” secures a component against displacement and/or rotation. A clamp has two clamping jaws which can be moved in relation to each other by actuation of the clamp. The clamp is adapted for assuming at least two positions. A first position is the retaining position, where the component to be fixed is retained so that it can neither be displaced nor rotated in the clamped area of the component. In a second position being the opening position, the component to be fixed is not retained so as to be able to be inserted, adjusted and removed from the clamp.

A “clamping jaw” is a component of a clamp. The component to be fixed by the clamp is contacted, in the retaining position, by a clamping jaw and fixed into place by counteraction of another clamping jaw.

A “filling needle” is a body traversed by a bore. The filling needle is adapted to be inserted in an opening and to be traversed by a substance passing through the bore thereof. In particular, by a filling needle a body is intended to be adapted to be positioned in an opening of a bag and to fill this bag by means of the bore inside the filling needle.

The state of the art until now has provided for bags, in particular bags for medical purposes, to be filled through a filling port. The filling port is a specific insertion component connected to the bag in such a way that it cannot be removed. In particular, such a filling port at first is a separate component welded at the rim of the bag thereinto and thus integrally connected to it.

WO2007/140760A2 and WO2010/025699A1 each disclose devices and methods for welding such a filling port into a bag.

In deviation from this, it is proposed here, to no longer fill a bag through a filling port welded into a bag as a separate component.

Instead, it is specifically proposed here to fill a bag through an opening in the bag which results from the fact that the bag is not welded over its entire circumference but has a recess in its nearly circumferential weld.

If this recess is suitably formed, a filling needle can be inserted into the area of the recess between the foils or limiting walls forming the bag, such that the needle can access the bag interior. In a second step, the bag is tensioned against the filling needle by means of a clamp so that it can no longer slide off the filling needle. Then the bag can be filled through the filling needle traversed by a bore.

Thus, the clamp can clamp the bag against the filling needle by form and counter-form such that the bag is tightly sealed, with the exception of the bore inside the filling needle.

It is conceivable to dimension and adapt the clamp, together with the filling needle and the bag, in such a way that the bag itself serves as the seal between the clamp and the bag.

A particularly suitable embodiment of the clamp and the filling needle will result in a positive engagement between the clamp and the filling needle or between the clamp and the bag and between the bag and filling needle.

In a suitable embodiment, clamping of the bag between the clamp and the filling needle can lead to an elastic or plastic deformation of the bag in the area of the bag opening and/or in the area of clamping, helping to further improve the properties of the clamp. One of these properties is the sealing tightness of the clamping, which can be improved by a special conformation of the sealing faces at the clamping jaws and/or the filling needle.

Advantageously, it can be achieved by means of the aspect of the invention disclosed here that bags no longer need a filling port in order to be filled, helping to reduce material, costs and processing times.

Another advantage can consist in the empty bags having a lower pack size, which helps to optimize the logistics for the bags.

Also, a lower disposal volume may advantageously result when a bag is disposed of, causing less damage to the environment.

Advantageously, it can also be achieved in this manner that the bag exhibits a higher degree of sealing tightness during filling, especially enclosing less air in the filled bag, which helps to optimize the pack size of filled bags.

Preferably, the clamp and the filling needle are in positive engagement with each other.

Thus, in a particularly well-suited embodiment of the clamp and the filling needle, a positive engagement between the clamp and the filling needle or between the clamp and the bag and between the bag and the filling needle is formed.

Advantageously, it can be achieved in this manner that the sealing tightness of the clamping joint between the clamp and the filling needle or between the clamp and the bag and between the bag and the filling needle can be improved.

Optionally, the positive engagement has a conical contact surface.

Some terminology will be explained in the following:

A “contact surface” is an area where bodies are in contact with each other.

A “conical contact surface” is an area where bodies are in contact, the contact surface being shaped conical, especially frustroconical.

Advantageously, due to the conical shape of the filling needle, the latter can be inserted faster and more easily through the opening in the bag, helping to reduce this part of the process time.

Also, due to the conical shape of the contact surface between the clamp and the filling needle or between the clamp and the bag and between the bag and the filling needle, the sealing tightness of the clamping joint can advantageously be improved. As a consequence, in particular less air may be enclosed in the filled bag, which helps to optimize the pack size of filled bags.

Preferably, the positive engagement has a plurality of contact surfaces.

Thus, it is conceivable, for instance, that the positive engagement has several contact surfaces which are interconnected by a gradation.

It is further conceivable that due to the presence of several contact surfaces, the positive engagement has a cone and an opposite cone.

Advantageously, it can be achieved in this manner that the sealing tightness between the clamp and the filling needle or between the clamp and the bag and between the bag and the filling needle can be improved, so that in particular less air may be enclosed in the filled bag, which helps to optimize the pack size of filled bags.

Optionally, the positive engagement has a groove.

Thus, the positive engagement can be provided with a circumferential sealing groove.

A supplementary sealing element can be integrated in this sealing groove.

In addition, the sealing groove can further improve the positive engagement by means of a tab and slot joint.

Advantageously, in this manner, the sealing tightness between the clamp and the filling needle or between the clamp and the bag and between the bag and the filling needle can be improved so that in particular less air may be enclosed in the filled bag, which helps to optimize the pack size of filled bags.

Preferably, the positive engagement is adapted to hermetically seal the region between the clamping jaws and the filling needle.

Optionally, the positive engagement is adapted to hermetically clamp the bag between the clamping jaws and the filling needle.

Advantageously, in this manner, less air can be enclosed in the filled bag, which helps to optimize the pack size of filled bags, in turn optimizing the logistics for filled bags.

Preferably, the clamp includes an elastomer.

Some terminology will be explained in the following:

An “elastomer” is a dimensionally stable but elastically deformable plastic. It can elastically deform under tensile or pressure load, but will resume its original non-deformed shape when the load is removed.

Thus, it is conceivable, for instance, in an advantageous embodiment, that the clamp and/or a clamping jaw and/or both clamping jaws and/or part of a clamping jaw and/or part of both clamping jaws consist of an elastomer.

Advantageously, in this manner, the seal between the clamping jaw and the foil and/or between the first clamping jaw and the second clamping jaw and/or between the first clamping jaw and the first foil and/or between the first foil and the second foil and/or between the second foil and the second clamping jaw and/or between the clamping jaw and the foil and/or between the clamping jaw and the filling needle can be improved due to the effect of an elastomer.

In a second aspect of the invention, the task is solved by a bag contour welding tool for welding a foil to form an open bag, the bag contour welding tool having a recess between two head lines.

Some terminology will be explained in the following:

A “bag contour welding tool” is a tool for manufacturing an open or closed bag which is adapted to weld a bag at its rims and thus to produce a seam between the two limiting walls.

A “foil” designates in particular a thin plastic sheet.

An “open bag” is a bag having an opening at least in one position, through which an object, in particular a liquid, can be introduced or discharged.

A “head line” is a line of a weld produced by means of a welding tool, which extends at the head of a bag, the head of a bag representing the upper rim of an upright or suspended bag, in particular of an open bag whose opening is at the top. If a bag is open at the top, the head line is generally divided by the opening so that there can be two head lines, especially one to the right of the opening and one to the left of the opening.

A “recess” is an interruption of a weld. In particular, an open bag can have a recess leading to the opening of the bag and through the opening to the interior of the bag.

Thus it is conceivable, for instance, that an open bag is manufactured from a foil by means of a bag contour welding tool, the bag having an opening formed by an interruption or recess of a contour weld line.

Physically, this means that if suitably constructed, the bag contour welding tool has a recess.

Thus, with a particularly well-suited bag contour welding tool, a filling port or other insertion piece for filling the bag is not necessary.

Advantageously, it can be achieved with the aspect of the invention introduced here that open bags can be manufactured easily and inexpensively. This helps to advantageously reduce processing times in a respective plant.

Another advantage can consist in the fact that the empty bags have a reduced pack size, which helps to optimize the logistics for the bags.

Also in case of disposal of a bag, a lower disposal volume can advantageously result, which helps to reduce impact on the environment.

Preferably, the bag contour welding tool extends directly adjacent to the recess, normal with respect to the head lines, in the direction of a foot line.

Some terminology will be explained in the following:

A “foot line” is the line of a weld manufactured with a welding tool which extends at the bottom of a bag, with the bottom of the bag forming the lower rim of an upright or suspended bag, in particular of an open bag whose opening is at the top.

In this manner, the bag can be designed such that the weld of manufacturing an open bag extends not only on the rim of the bag but also in the area bordering on the opening of the bag, extending further into the bag interior.

With a suitable design, the welds forming the opening of the bag extend in parallel toward the foot line of the bag.

This can result in an opening which, with an ideally thin weld, not only has an opening line but also an opening area. The opening area, in particular, can be rectangular so that if the bag is open, it can be filled by means of a cylindrical or elliptical filling needle and so that the welding lines extend in parallel to the filling needle in the recess area.

Additionally, these welding lines forming the opening can extend at such an angle with respect to each other that a trapezoidal opening area results.

In a particularly well-suited embodiment, the welds extending into the bag interior are formed such that if the bag is open, it can be filled by means of a conical filling needle and such that the welding lines extend in parallel to the filling needle in the recess area.

Advantageously, in this manner, it can be manufactured with the contour welding tool described here which, due to the geometry of its welds in the area of the bag opening, promotes sealing tightness of the connection between the bag and the filling needle while the bag is filled by means of a filling needle.

Advantageously, it can also be achieved in this manner that less air is enclosed in the bag manufactured in this way during filling, which helps to optimize the pack size of filled bags, in turn optimizing the logistics for filled bags.

The bag contour welding tool optionally extends, starting from the recess beneath the head-lines, in the direction of the corners between the head-lines and the lateral lines in the form of a loop.

Some terminology will be explained in the following:

A “loop” is a welding line forming an indentation at the center. This indentation can be open or closed.

A “corner” is a harmonic or disharmonic transition between a lateral line and a head line or between a lateral line and a foot line.

A “lateral line” is a line of a weld which has been manufactured with a welding tool and extends on one side of a bag, the side of the bag forming the right or left rim of an upright or suspended bag, in particular of an open bag whose opening is at the top.

Thus, for instance, it is conceivable to manufacture a bag with a respective bag contour welding unit the welds of which, in the area of the opening, first extend into the interior of the bag and then continue to form an open loop in the direction of a head-line, a lateral line or a corner.

Advantageously, the tensions in the area of the bag opening can generally be affected by the loop geometry of the upper weld, during filling or during general use of the bag, such that the degree of tension in the bag material can be reduced.

Preferably, an area limited by the loop of the bag contour welding tool has a closed rim.

Some terminology will be explained in the following:

A “rim” is understood to be a continued welding line which forms an open indentation.

A “closed rim” is a continued welding line which forms a closed indentation.

Thus, for instance, it is conceivable to manufacture a bag with a respective bag contour welding unit the welds of which, in the area of the opening, first extend into the interior of the bag and then form a closed loop with a head-line, a lateral line or a corner of the bag.

In a particularly advantageous embodiment, it is also conceivable that in the area of the indentation of a loop, a fastening device for the bag can be provided, in particular a lug or a recess of the foil in the indentation, so that the bag can be very easily suspended in an upright manner from this opening.

Advantageously, it can be achieved in this manner that the tensions in the area of the bag opening can generally be affected by the loop geometry of the upper weld line, during filling or during general use of the bag, such that the degree of tension in the bag material can be reduced.

Another advantageous result may be that the bag can be easily suspended in an upright manner by means of a lug or a recess in the foil in the area of the indentation.

It is explicitly pointed out that the subject matter of the second aspect can advantageously be combined with the subject matter of the first aspect of the invention.

In a third aspect of the invention, the task is solved by a device for filling a bag, in particular a bag which has been manufactured with a bag contour welding unit according to the second aspect of the invention, with the device having a filling needle.

Until now, the state of the art has provided for bags, in particular bags for medical purposes, to be filled by means of a filling port. This filling port is a specific insertion piece which is joined to the bag in such a way that it cannot be removed. In particular, such a filling port at first is a separate component welded into the rim of the bag and thus integrally connected to it.

WO2007/140760A2 and WO2010/025699A1 each disclose devices and methods for welding such a filling port into a bag. In deviation from this, it is proposed here to no longer fill a bag through a filling port welded into a bag as a separate component.

Instead, it is specifically proposed here to fill a bag through an opening in the bag by means of a filling needle, which opening is formed by not welding the bag over its entire circumference but by leaving a recess in a nearly circumferential weld.

In a particularly well-suited embodiment, the filling needle is formed such that it can be inserted in an opening of an open bag and subsequently the bag can be filled through a bore formed inside the filling needle.

In another particularly well-suited embodiment, the filling needle and a welding line at the opening of a bag are shaped correspondingly such that a seal between the filling needle, inserted in an opening of an open bag corresponding to the filling needle, and the bag is formed. Thus, the seal between the filling needle and the bag in this particularly well-suited embodiment can only be formed by means of an adaptation of the contour of the welding line to the shape of the filling needle and/or vice versa. Thus, it is possible, for instance, to do without a clamping device or to refrain from specifically adapting the clamping device to the shape of the filling needle and/or to the opening of the bag.

Advantageously, it can be achieved by the aspect of the invention proposed here that bags no longer need to have a filling port in order to be filled. This helps to save material, costs and processing time.

Another advantage can consist in the fact that the empty bags have a lower pack size, which helps to optimize the logistics for the bags.

Also, a lower disposal volume may advantageously result when a bag is disposed of, causing less impact on the environment.

Additionally, a seal between the bag and the filling needle can advantageously be achieved even without a corresponding clamping unit.

Preferably, the filling needle has an area with a cross-section which is homogeneous over the entire extension of the filling needle.

Some terminology will be explained in the following:

A “direction of extension” is the main direction in which something extends. In particular, by a direction of extension, a direction is intended in which the filling needle extends, i. e. the direction in which the contour of the forming tool shows only minor changes. In particular, the direction of extension coincides with the axial direction of the bore inside the filling needle. The direction of extension points to the end of the filling needle which is inserted in the bag before the bag is filled.

Thus, the filling needle can have a cylindrical or elliptical or a different cross-section and a bore on the inside.

Advantageously, in this manner, contouring of the bag to be filled in the area of the bag opening can be performed comparatively easily and inexpensively.

Optionally, the filling needle can have an area with a cross-section which expands in opposition to the direction of extension of the filling needle.

Thus, with a suitable design, the filling needle can have the conical geometry of a truncated cone with a bore on the inside.

Advantageously, in this manner, a seal can be achieved between the bag and the filling needle with a conical geometry, which helps to enclose less air in the bag while the same is filled, helping to optimize the pack size of filled bags, which in turn helps to optimize the logistics for filled bags.

It is explicitly pointed out that the subject matter of the third aspect can advantageously be combined with the subject matter of the above aspects of the invention, both individually and cumulatively in any combination.

In a fourth aspect of the invention, the task is solved by a welding tool for hermetically sealing an opening of a bag, in particular a bag which has been manufactured with a bag contour welding unit according to the second aspect of the invention and/or a bag which has been filled by a device according to the first or the third aspect of the invention, the welding tool having a welding electrode and the welding electrode having a surface relief.

Some terminology will be explained in the following:

A “welding tool” is a device for combining two components by means of a weld. It is a tool with a welding electrode which is heated and pressed onto an area to be welded. In particular, also two parts of two components can be combined, especially to form the opening of a bag.

A “welding electrode” is a component of a welding tool which is heated and then pressed onto the components to be combined.

A “surface relief” describes the surface structure, in particular the distribution of protrusions and recesses, in a surface as well as their irregularities and shapes, in particular the surface structure of a welding electrode.

A “closed bag” is a bag which has no opening in any place through which an object, in particular a liquid, could be received or discharged.

It is specifically conceivable, among others, that a filled or empty open bag is welded by means of a welding tool such that the bag is no longer open but closed.

In a particularly advantageous embodiment of the welding tool, it is thus possible to hermetically close an open bag.

A welding tool for welding a bag opening can have a prominent surface relief which makes it possible to form a pattern in the weld or the welding area.

Advantageously, with the aspect of the invention introduced here, a bag which has been filled without a filling port can be hermetically sealed by a welding tool after filling.

Preferably, the surface relief of the welding electrode has a welding pattern.

Some terminology will be explained in the following:

A “welding pattern” is understood to be a surface relief of a welding electrode which follows geometrical rules and which is so prominent that it can be perceived as a remaining pattern in the weld or the welding area.

Thus, a welding pattern can be, for instance, a check pattern formed by lines with a constant height.

A pattern which has the form of lozenges, or resembles the pattern of a waffle, is conceivable as well.

Advantageously, in this manner, particularly tightly sealed welding of an opening of a previously opened bag can be performed by means of a welding electrode with a welding pattern.

Also, it can advantageously be achieved in this manner that any liquid in the bag opening which remains in the area of the weld joint during welding is enclosed between the lines of the pattern and can remain there.

Optionally the welding pattern of the welding electrode is closed.

A closed welding pattern has sealed cavities when pressed against a planar surface.

One example of a closed welding pattern is a check pattern or a honeycomb pattern.

Advantageously, in this manner, a particularly tight seal of an opening of a previously opened bag can be achieved by means of a welding electrode having a welding pattern, which electrode also constitutes an excellent protection against failure. In case one of the welds should unexpectedly become loose, still no additional opening is formed in the bag, further preventing liquid in the bag from issuing.

Preferably, the welding pattern of the welding electrode is open.

An open welding pattern is understood to be the opposite of a closed welding pattern.

Examples of open welding patterns are the inverse shapes of a check pattern or a honeycomb pattern.

If an inverse check pattern is pressed against a planar surface, there are only point contacts between the open welding pattern and the planar surface.

A particularly advantageous embodiment of an open welding pattern is an open welding pattern terminating in a welding line on the level of the weld points such that the welding line seals the bag in one line and such that above this line, there is the pattern structure of the spot-welding pattern.

Advantageously, it can be achieved in this manner that in case liquid is present in the bag opening in the area of the weld joint at the time of welding, this liquid can penetrate to the outside through the open pattern.

Advantageously, it can also be achieved in this manner that filling and welding can take place very quickly and that no liquid drops in the welding area of the bag opening have to be taken into account.

It is explicitly pointed out that the subject matter of the fourth aspect can advantageously be combined with the subject matter of the above aspects of the invention, both individually and cumulatively in any combination.

In a fifth aspect of the invention, the task is solved by a method of filling a bag with a device according to the first aspect of the invention, with the clamping jaws holding or holding and translating the bag, the filling needle being inserted in the area of the bag opening between a first foil of the bag and a second foil of the bag and the bag being filled through a channel inside the filling needle.

Some terminology will be explained in the following:

A “channel” is understood to be a shape through which a substance can flow. In a particularly simple case, a channel is a bore inside the filling needle.

Until now, the state of the art has provided for bags, in particular bags for medical purposes, to be filled by means of a filling port. This filling port is a specific insertion piece connected to the bag in such a way that it cannot be removed. In particular, such a filling port is at first a separate component which is then welded into the rim of the bag and thus integrally connected to it.

WO2007/140760A2 and WO2010/025699A1 each disclose devices and methods of welding such a filling port into a bag.

In deviation from this, it is proposed here to no longer fill a bag by means of a filling port which is welded into a bag as a separate component.

Instead, it is specifically proposed here to fill a bag through an opening in the bag which is formed due to the fact that the bag is not welded over its entire circumference but has a recess in a nearly circumferential weld.

If this recess is suitably designed, a filling needle can be fitted between the foils or boundary walls forming the bag in the area of the recess so that the filling needle can access the interior of the bag. In a second step, the bag is tensioned against the filling needle by means of a clamp so that it can no longer slide off the needle. Then the bag can be filled through the filling needle through which a bore passes.

In this way, the clamp can clamp the bag against the filling needle by form and counter-form such that the bag is tightly sealed, with the exception of the bore inside the filling needle.

Furthermore, it is conceivable that in cooperation with the filling needle and the bag, the clamp is dimensioned and designed such that the bag itself serves as a seal between the clamp and the bag.

If the clamp and the filling needle are particularly suitably designed, there is positive engagement between the clamp and the filling needle or between the clamp and the bag and between the bag and the filling needle.

In a suitable embodiment, an elastic or plastic deformation of the bag in the area of the bag opening and/or in the clamping area can occur when the bag is clamped, which can help to further improve the properties of the clamp. Such a property is the sealing tightness of clamping which can be improved by a special conformation of the sealing surfaces of the clamping jaws and/or the filling needle.

Also, in a suitable embodiment, it is conceivable that the clamping jaws can be used to move the bags through the station or the plant.

With the aspect of the invention introduced here, it can advantageously be achieved that bags no longer need a filling port in order to be filled. This helps to save material, costs and processing time.

Another advantage can consist in a lower pack size of the empty bags, which helps to optimize the logistics for the bags.

In case of bag disposal, a lower disposal volume can advantageously result, which helps to reduce the impact on the environment.

Advantageously, it can also be achieved in this manner that during filling, the bag has a higher degree of sealing tightness so that, in particular, less air is enclosed in the filled bag, which helps to optimize the pack size of filled bags.

Preferably, the first foil of the bag and the second foil of the bag are plastically deformed by a preforming tool in the area of the bag opening before the filling needle is inserted.

Some terminology will be explained in the following:

A “preforming tool” designates a tool suitable for deforming a foil, in particular for elongation of a foil in at least a portion of the foil.

Advantageously, in this manner, the filling needle can be inserted more easily, thus reducing the process throughput time.

Optionally, the first foil of the bag and the second foil of the bag are pulled apart before the filling needle is inserted.

Advantageously, in this manner, the filling needle can be inserted more easily, thus reducing the process throughput time.

Preferably, the first foil of the bag and the second foil of the bag are clamped between the clamping jaws and/or between the clamping jaws and the filling needle.

Advantageously, it can be achieved also in this manner that during filling, the bag has a higher degree of sealing tightness so that, in particular, less air is enclosed in the filled bag, which helps to optimize the pack size of filled bags.

Optionally, the clamping effect is increased by additional pressure on the positive engagement.

Advantageously, it can be achieved also in this manner that during filling, the bag has a higher degree of sealing tightness so that, in particular, less air is enclosed in the filled bag, which helps to optimize the pack size of filled bags.

Preferably, the clamped foil acts as a seal between the clamping jaws and/or between the clamping jaws and the filling needle.

Advantageously, it can also be achieved in this manner that the foil acts as an additional sealing element and that during filling, the bag has a higher degree of sealing tightness so that, in particular, less air is enclosed in the filled bag, which helps to optimize the pack size of filled bags.

Optionally, the filling needle is pressed against the clamping jaws.

Advantageously, it can be achieved also in this manner that during filling, the bag has a higher degree of sealing tightness so that, in particular, less air is enclosed in the filled bag, which helps to optimize the pack size of filled bags.

It is explicitly pointed out that the subject matter of the fifth aspect can advantageously be combined with the subject matter of the above aspects of the invention, both individually and cumulatively in any combination.

In a sixth aspect of the invention, the task is solved by a method of filling a bag with a device according to the third aspect of the invention, in particular for filling a bag manufactured with a bag contour welding tool according to the second aspect of the invention, the bag being positioned by means of a transport system, the filling needle being inserted in the area of the bag opening between a first foil of the bag and a second foil of the bag and the bag being filled through a channel inside the filling needle.

Some terminology will be explained in the following:

A “transport system” is any system suitable and adapted for the transport and positioning of bags.

Until now, the state of the art has provided for bags, especially bags for medical purposes, to be filled by means of a filling port. Such a filling port is a specific insertion piece which is connected to the bag in such a way that it cannot be removed. In particular, such a filling port is, at first, a separate component welded at the rim of the bag into the bag and thus is integrally connected to it.

WO2007/140760A2 and WO2010/025699A1 each disclose devices and methods for welding such a filling port into a bag.

In deviation from this, it is proposed here to no longer fill a bag through a filling port which is welded into a bag as a separate component.

Instead, it is specifically proposed here to fill a bag through an opening in the bag, which is produced by not welding the bag over its entire circumference but by leaving a recess in a nearly circumferential weld.

With suitable design of this recess, a filling needle can be fitted between the foils or boundary walls forming the bag in the area of the recess so that the filling needle can access the interior of the bag. Then the bag can be filled through the filling needle traversed by a bore.

Advantageously, with the aspect of the invention proposed here, the bags no longer need a filling port in order to be filled, which helps to save material, costs and processing time.

Another advantage can be that the empty bags have a lower pack size, which helps to optimize the logistics for the bags.

Also, a lower disposal volume may advantageously result when a bag is disposed of, reducing the impact on the environment.

Preferably, the first foil of the bag and the second foil of the bag are elastically deformed by means of a preforming tool before the filling needle is inserted in the bag opening area.

Advantageously, in this manner, the filling needle can be inserted more easily, thus reducing the process throughput time.

Optionally, the first foil of the bag and the second foil of the bag are pulled apart before the filling needle is inserted.

Advantageously, in this manner, the filling needle can be inserted more easily, thus reducing the process throughput time.

Preferably, the filling needle is pressed against the weld of the bag.

Advantageously, it can be achieved also in this manner that the bag can have a higher degree of sealing tightness during filling so that in particular less air is enclosed in the filled bag, which helps to optimize the pack size of filled bags.

Optionally, the filling needle can be clamped to the weld of the bag.

Advantageously, it can be achieved also in this manner that during filling, the bag has a higher degree of sealing tightness so that in particular less air is enclosed in the filled bag, which helps to optimize the pack size of filled bags.

Preferably, the filling needle is sealed against the weld of the bag.

Advantageously, it can be achieved also in this manner that during filling, the bag has a higher degree of sealing tightness so that in particular less air is enclosed in the filled bag, which helps to optimize the pack size of filled bags.

Optionally, the filling needle is removed from the bag and the opening of the bag is welded or welded and sealed by means of a welding tool according to the fourth aspect of the invention.

Advantageously, in this manner, the bag can immediately be welded or welded and sealed after filling, which helps to reduce the throughput times and to ensure that no substances can penetrate to the outside from the bag's interior.

It is explicitly pointed out that the subject matter of the sixth aspect can advantageously be combined with the subject matter of the above aspects of the invention, both individually and cumulatively in any combination.

In a seventh aspect of the invention, the task is solved by a method of manufacturing a bag with a bag contour welding tool according to the second aspect of the invention.

It is understood that the advantages of a bag contour welding tool according to the second aspect of the invention as described above directly extend to a method of manufacturing a bag by means of a generic bag contour welding tool.

It is explicitly pointed out that the subject matter of the seventh aspect can advantageously be combined with the subject matter of the above aspects of the invention, both individually and cumulatively in any combination.

In an eighth aspect of the invention, the task is solved by a plant for manufacturing and filling a bag, with the bag being manufactured with a bag contour welding unit according to the second aspect of the invention and/or with a device according to a first or a third aspect of the invention, and/or with the opening of the same being welded with a welding tool according to the fourth aspect of the invention and/or being filled with a method according to the fifth or the sixth aspect of the invention and/or being manufactured with a method according to the seventh aspect of the invention.

It is understood that the advantages of a bag, where the bag is manufactured with a bag contour welding unit according to the second aspect of the invention and/or is filled with a device according to a first or a third aspect of the invention and/or the opening of the same is welded with a welding tool according to the fourth aspect of the invention and/or is filled with a method according to the fifth or the sixth aspect of the invention and/or is manufactured with a method according to the seventh aspect of the invention, as described above, directly extend to a plant for manufacturing and filling a bag, the bag being manufactured with a bag contour welding unit according to the second aspect of the invention and/or filled with a device according to a first or a third aspect of the invention, and/or with the opening of the same being welded with a welding tool according to the fourth aspect of the invention and/or being filled with a method according to the fifth or the sixth aspect of the invention and/or being manufactured with a method according to the seventh aspect of the invention.

It is explicitly pointed out that the subject matter of the eighth aspect can advantageously be combined with the subject matter of the above aspects of the invention, both individually and cumulatively in any combination.

In a ninth aspect of the invention, the task is solved by a bag manufactured and filled by a plant according to the eighth aspect of the invention.

It is understood that the advantages of a plant for manufacturing and filling a bag, with the bag being manufactured with a bag contour welding device according to the second aspect of the invention and/or being filled with a device according to a first or a third aspect of the invention, and/or with the opening of the same being welded with a welding tool according to the fourth aspect of the invention and/or being filled with a method according to the fifth or the sixth aspect of the invention and/or being manufactured with a method according to the seventh aspect of the invention, as described above, directly extend to a bag manufactured and filled with a plant according to the eighth aspect of the invention.

It is explicitly pointed out that the subject matter of the ninth aspect can advantageously be combined with the subject matter of the above aspects of the invention, both individually and cumulatively in any combination.

In the following, the invention will be explained in more detail using an example of embodiment with reference to the drawings wherein

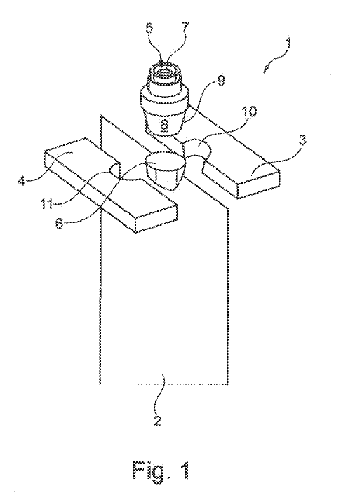

FIG. 1 schematically shows a perspective view of a first embodiment of a device for filling a medical bag,

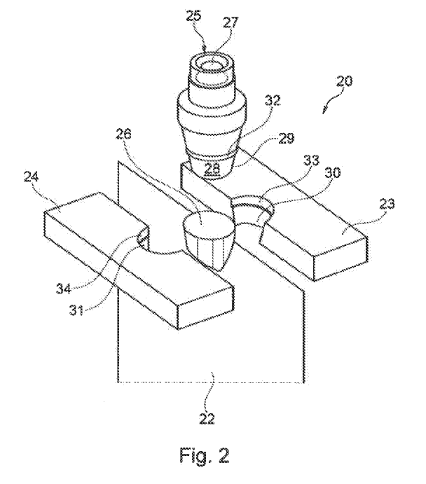

FIG. 2 schematically shows a perspective view of a second embodiment of a device for filling a bag,

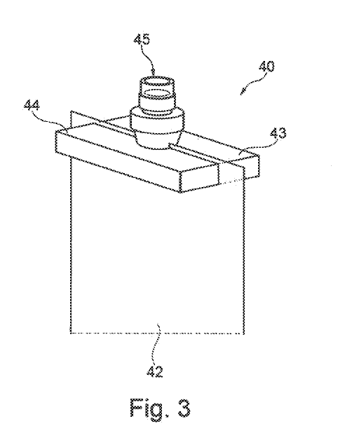

FIG. 3 schematically shows a perspective view of the device for filling a bag from FIG. 1 or 2, in a closed state,

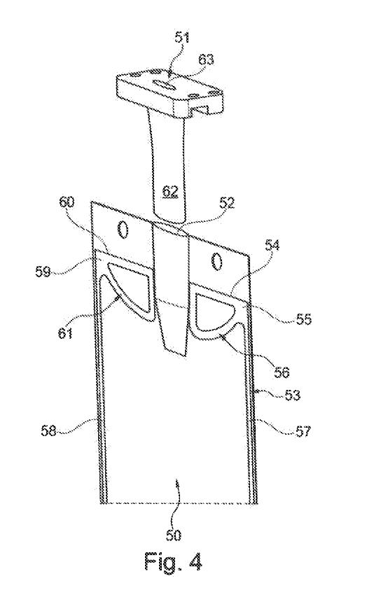

FIG. 4 schematically shows a perspective view of a filling needle and a bag,

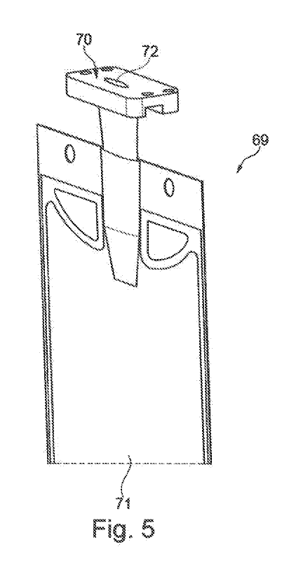

FIG. 5 shows the filling needle and the bag from FIG. 4, with the filling needle inserted in the bag, and

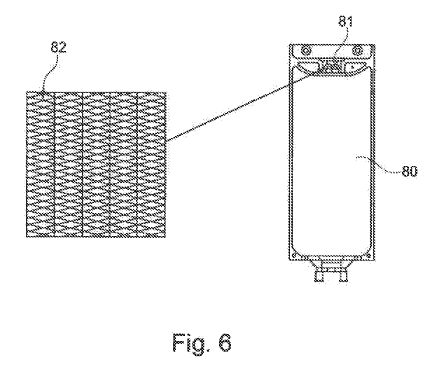

FIG. 6 schematically shows a view of a bag with a welding pattern as well as the welding pattern in a schematical enlarged detail view.

The device 1 for filling the bag 2 in FIG. 1 substantially consists of a first clamping jaw 3, a second clamping jaw 4 and a filling needle 5.

The bag 2 has already been pre-stretched in the area of an opening 6 by means of a preforming tool (not shown).

The filling needle 5 has a through bore 7 through which the bag 2 can be filled.

The filling needle 5 also has a conical outer geometry 9 in a clamping region 8.

Inversely to the geometry 9 of the clamping region 8 of the filling needle 5, each of the clamping jaws 3, 4 has a conical inner geometry 10, 11 adapted to form a positive engagement (not shown) with the conical outer geometry 9.

The bag 2 can serve as a seal between the clamping region 8 of the filling needle 5 and the conical geometry 10, 11 of the clamping jaws 3, 4.

For filling the bag 2, the bag 2 is first clamped by the clamping jaws 3, 4. Thereafter the filling needle 5 is inserted in the pre-stretched opening 6 of the bag 2 such that positive engagement (not shown) between the geometry 9 and the geometries 10, 11 results. Subsequently a substance (not shown) can be filled into the bag 2 through the bore 7 of the filling needle 5.

When the bag 2 has been filled, the filling needle 5 is removed out of the bag 2 and then the bag 2 is moved away so that the device 1 for filling a bag 2 is free for the next bag (not shown).

The device 20 for filling a bag 22 in FIG. 2 substantially consists of a first clamping jaw 23, a second clamping jaw 24 and a filling needle 25.

The bag 22 has already been pre-stretched in the area of its opening 26 by means of a preforming tool (not shown).

The filling needle 25 has a through bore 27 through which the bag 22 can be filled.

The filling needle 25 also has a conical geometry 29 in a clamping region 28.

The clamping jaws 23, 24 each have a conical geometry 30, 31 inverse to the geometry 29 of the clamping region 28 of the filling needle 25, which geometry is adapted to form a positive engagement (not shown) with the geometry 29.

The filling needle 24 further has a groove 32. For allowing this groove to positively engage the clamping jaws 23, 24 from the top, the clamping jaws 23, 24 each have a cylindrical geometry 33, 34 which makes it possible to insert the filling needle 25 in the closed state (not shown) of the clamping jaws 23, 24 from the top to the point that the conical clamping region 28 can positively engage the conical geometries 30, 31.

The groove 32 of the filling needle 25 promotes the sealing tightness between the filling needle 25, the bag 22 and the clamping jaws 23, 24.

The bag 22 can serve as a seal between the clamping region 28 of the filling needle 25 and the conical geometry 30, 31 of the clamping jaws 23, 24.

For filling the bag 22, the bag 22 is initially clamped by the clamping jaws 23, 24. Then the filling needle 25 is inserted in the pre-stretched opening 26 of the bag 22 such that a positive engagement (not shown) between the geometry 29 and the geometries 30, 31 results. Subsequently a substance (not shown) can be filled into the bag 22 through the bore 27 of the filling needle 25.

When the bag 22 has been filled, the filling needle 25 is removed from the bag 22 and then the bag 22 is moved away so that the device 20 for filling a bag 22 is free for the next bag (not shown).

The device 40 for filling a bag 42 in FIG. 3 substantially consists of a first clamping jaw 43, a second clamping jaw 44 and a filling needle 45.

The device 40 substantially corresponds to the devices 1, 20 described above and is in a clamped state in which the bag 42 can be filled.

The bag 50 and the filling needle 51 in FIG. 4 are designed such that the filling needle 51 can be used for filling the bag 50.

For this purpose, the bag 50 is pre-formed by means of a preforming tool (not shown) in the region of its opening 52 so that the filling needle 51 can easily be inserted in the bag 50.

The bag 50 has a weld 53, consisting of a first head line 54, a first upper corner 55, a first closed loop 56, a first lateral line 57, a first lower corner (not shown), a foot line (not shown), a second lower corner (not shown), a second lateral line 58, a second upper corner 59, a second head line 60 and a second closed loop 61.

The filling needle 51 has a region with an elliptical geometry 62 and a bore 63 through which the bag 50 can be filled.

For filling of the bag 50, the filling needle 51 is inserted in the preformed opening 52 of the bag 50. Subsequently, a substance is filled into the bag 50 through the bore 63 of the filling needle 51.

When the bag 50 has been filled, the filling needle 51 is removed from the bag 50 and then the bag 50 is moved away so that the filling needle 51 for filling a bag 50 is free for the next bag (not shown).

The device 69 for filling a bag 71 in FIG. 5 substantially consists of a filling needle 70 and a bag 71.

The filling needle 70 is inserted in the bag 71 such that the bag 71 can be filled through the bore 72 in the filling needle 70.

The bag 80 in FIG. 6 is filled and welded in the region 81 of its opening (not shown) by means of a welding tool (not shown). The welding tool (not shown) has the closed welding pattern 82 with which the bag 80 was tightly sealed in the region 81 of its opening (not shown).

### LIST OF REFERENCE NUMBERS

1 device
2 bag
3 first clamping jaw
4 second clamping jaw
5 filling needle
6 opening
7 bore
8 clamping region
9 geometry
10 geometry
11 geometry
20 device
22 bag
23 clamping jaw
24 clamping jaw
25 filling needle
26 opening
27 bore
28 clamping region
29 geometry
30 geometry
31 geometry
32 groove
33 geometry
34 geometry
40 device
42 bag
43 clamping jaw
44 clamping jaw
45 filling needle
50 bag
51 filling needle
52 opening
53 weld
54 head line
55 corner
56 loop
57 lateral line
58 lateral line
59 corner
60 head line
61 loop
62 geometry
63 bore
69 device
70 filling needle
71 bag
72 bore
80 bag
81 region
82 welding pattern

1. Device for filling a bag for medical purposes,
characterized in that
the device has a clamp with two clamping jaws and one filling needle,
the clamp being adapted to clamp the bag between the filling needle and the clamping jaws.

2. Device according to claim 1, characterized in that the clamp and the filling needle are in positive mutual engagement.

3. Device according to claim 2, characterized in that the positive engagement has a conical contact surface.

4. Device according to claim 2, characterized in that the positive engagement has a plurality of contact surfaces.

5. Device according to claim 2, characterized in that the positive engagement has a groove.

6. Device according to claim 2, characterized in that the positive engagement is adapted to provide an airtight seal between the clamping jaws and the filling needle.

7. Device according to claim 2, characterized in that the positive engagement is adapted to hermetically clamp the bag between the clamping jaws and the filling needle.

8. Device according to claim 1, characterized in that the clamp has an elastomer.

9. Bag contour welding tool for welding a foil to form an open bag,
characterized in that
the bag contour welding tool has a recess between two head lines.

10. Bag contour welding tool according to claim 9, characterized in that the bag contour welding tool extends in a normal direction to the head lines in the direction of a foot line, directly adjacent to the recess.

11. Bag contour welding tool according to claim 9, characterized in that the bag contour welding tool, starting from the recess beneath the head lines, extends in the direction of the corners between the head lines and the lateral lines in the form of a loop.

12. Bag contour welding tool according to claim 9, characterized in that an area limited by the loop of the bag contour welding tool has a closed boundary.

13. Device for filling a bag, the bag being manufactured with a bag contour welding unit according to claim 9,
characterized in that
the device has a filling needle.

14. Device according to claim 13, characterized in that the filling needle has an area with a cross-section which is constant in the direction of extension of the filling needle.

15. Device according to claim 13, characterized in that the filling needle has area with a cross-section which expands in opposition to the direction of extension of the filling needle.

16. Welding tool for airtight sealing of an opening of a bag for medical purposes with a bag contour welding unit according to claim 9,
characterized in that
the welding tool has a welding electrode and the welding electrode has a surface relief.

17. Welding tool according to claim 16, characterized in that the surface relief of the welding electrode has a welding pattern.

18. Welding tool according to claim 17, characterized in that the welding pattern of the welding electrode is closed.

19. Welding tool according to claim 17, characterized in that the welding pattern of the welding electrode is open.

20. Method of filling a bag with a device according to claim 1,
characterized in that
the clamping jaws hold the bag or hold and move it,
the filling needle is inserted in the region of a bag opening between a first foil of the bag and a second foil of the bag
and the bag is filled through a channel inside the filling needle.

21. Method according to claim 20, characterized in that the first foil of the bag and the second foil of the bag are plastically deformed by a preforming tool in the area of the bag opening before the filling needle is inserted.

22. Method according to claim 20, characterized in that the first foil of the bag and the second foil of the bag are pulled apart before the filling needle is inserted.

23. Method according to claim 20, characterized in that the first foil of the bag and the second foil of the bag are clamped between the clamping jaws and/or between the clamping jaws and the filling needle.

24. Method according to claim 23, characterized in that the clamping effect is increased by additional pressure on the positive engagement.

25. Method according to claim 23, characterized in that the clamped foil acts as a seal between the clamping jaws and/or between the clamping jaws and the filling needle.

26. Method according to claim 20, characterized in that the filling needle is pressed against the clamping jaws.

27. Method of filling a bag with a device that has a filling needle, the bag being manufactured with a bag contour welding tool according to claim 9,
characterized in that
the bag is positioned by a transport system,
the filling needle is inserted between a first foil of the bag and a second foil of the bag in the area of the bag opening
and the bag is filled through a channel inside the filling needle.

28. Method according to claim 27, characterized in that the first foil of the bag and the second foil of the bag are plastically deformed by a preforming tool in the area of the bag opening before the filling needle is inserted.

29. Method according to claim 27, characterized in that the first foil of the bag and the second foil of the bag are pulled apart before the filling needle is inserted.

30. Method according to claim 27, characterized in that the filling needle is pressed against the weld of the bag.

31. Method according to claim 27, characterized in that the filling needle is clamped against the weld of the bag.

32. Method according to claim 27, characterized in that the filling needle is sealed against the weld of the bag.

33. Method according to claim 20, characterized in that the filling needle is removed from the bag and the opening of the bag is welded or welded and closed by means of a welding tool according to one of claims 16-19.

34. Method of manufacturing a bag with a bag contour welding tool according to claim 9.

35. Plant for manufacturing and filling a bag, with the bag being manufactured with a bag contour welding unit according to claim 9.

36. Bag which is manufactured and filled with a plant according to claim 35.
